(19) United States
(12) Patent Application Publication
(10) Pub. No.: US 2013/0263508 A1
(43) Pub. Date: Oct. 10, 2013

(54) Growth Substrate Product, Methods of Growing Plants and Processes of Making Growth Substrate

(71) Applicants: Jean Marie Wilhelmus Cuypers, Linne (NL); Eelke Gjalt Hempenius, Deest (NL)

(72) Inventors: Jean Marie Wilhelmus Cuypers, Linne (NL); Eelke Gjalt Hempenius, Deest (NL)

(21) Appl. No.: 13/703,208

(22) PCT Filed: Jun. 30, 2011
(86) PCT No.: PCT/EP2011/061066

§ 371 Date: Jun. 21, 2013

(30) Foreign Application Priority Data
Jun. 30, 2010 (EP) 10167975.1

(51) Int. Cl. A01G 31/00

(52) U.S. Cl. CPC A01G 31/001
USPC 47/59 S

(57) ABSTRACT

This invention includes a coherent growth substrate product formed of mineral wool, the product having two opposed top and bottom surfaces and a channel which is open at the bottom surface and extends from the bottom surface at least 50% of the height of the growth substrate product and wherein the volume of the growth substrate product is not more than 150 cm³.

The present invention relates to methods of propagation of seeds and to products for use in such methods and to processes of making these products.

The first stage of commercial growing of plants based on seeds is the propagation stage. It has been well known for many years to propagate seeds for fruit and vegetable and other crops in growth substrates formed from mineral wool. Usual practice is to position a seed in a small-volume growth substrate, which can be formed of mineral wool or other synthetic materials, in a cut-out at the top surface of the growth substrate. Once the plants have rooted and developed leaves in a first growth substrate they can then be transferred to the next growth stage, usually to another growth substrate of greater volume, either in the same facility or in another facility.

Propagation of seeds has conventionally been done for many years in a growth substrate which is relatively small in volume (usually described as a plug). It is also known, from our International Patent Publication WO2010/003677, to propagate seeds in a growth substrate of larger volume, up to 150 cm³.

It is the aim and the responsibility of the propagator to ensure rapid but strong and uniform growth of the seeds into seedlings and to ensure that the resulting seedlings have characteristics most appropriate for eventual strong growth into the final plants, optionally after transfer to a different facility and/or to another growth substrate. The optimum result for the propagator is that all seeds result in plants and all plants are of the highest quality.

One difficulty which arises is that of ensuring that all climatic conditions and the levels of water and oxygen supplied to the seed during the propagation stage are appropriate to obtain optimal properties of the seedlings. For instance, the seed needs contact with sufficient water to enable rapid and effective development of the first pin root and shoot, and rooting-in; however, if the growth substrate has too high a water content then the oxygen content tends to be too low. This results in roots which are too long and insufficiently strong. The result of the propagation stage should be a compact net of roots, but a low oxygen content can lead to a root net which is insufficiently compact. Ideally, for instance, a propagator would want a water content in the growth substrate of around 75% but in practice it is closer to 100%. This too-high water content leads to lower germination rates and lower plant quality. As a result, there is a tendency for propagators to water the growth substrates less often than might be desirable for rooting-in purposes.

For many years, despite these difficulties, propagators have worked with mineral wool plugs in the manner described above, and have more recently worked with the system described in our publication WO2010/003677 and have used their skill and knowledge as propagators to manage the conditions and obtain the best possible growth under the circumstances.

However, it would be desirable to be able to provide a growth substrate which enables stronger but nevertheless rapid growth, leading to a resultant seedling which has optimised properties for later growth, including for instance a compact root net. The propagator also aims for the maximum possible germination ratio and for uniformity of the resultant plants.

It is known to propagate seeds in other growth substrates than mineral wool growth substrates.

For instance in DK 102550, a growth substrate block for plant cultivation made from sponge-like, natural or artificial material is provided which has an incision or a crack into which seeds, seedlings, shoots or the like are inserted and wedged in position with the help of the natural elasticity of the two parts adjacent the incision. Materials for the growth substrate mentioned in the description are porous plastic material, peat possibly mixed with wood pulp, the materials being soaked in a mix of soil, clay, nutrients and water. The incision is positioned such that it is parallel to the ground when the growth substrate product is in use.

EP-A-252191 relates to a synthetic substrate such as polyurethane foam for use in the rooting of cuttings and seedlings. The synthetic substrate is a dual-density product characterised by having at least one region of relatively low capillarity, which is intended for receiving a cutting or seedling to be propagated, and at least one region of relatively high density, which exhibits higher capillarity than the said low density region. The low density region may contain one or more blind bores for receiving cuttings or seedlings. This document does not discuss the use of mineral wool growth substrates.

U.S. Pat. No. 4,058,931 discloses a foam plant cultivation block with a seed hole, a bore from the bottom of the block to the seed hole and a transverse channel which allows fluid to pass right across the block. The block is preferably composed of a brittle foamed plastic having elongated tandem cells with porous walls, a pH value not exceeding 5.2 and a specific gravity between 3 and 15 kg/m³. The bore guides the roots through and out of the block into the nutrient fluid in the channel.

A foam block such as disclosed in US4058931 has a low density of between 3 and 15 kg/m³. Such a foam block is difficult to handle because of the low density and can easily become damaged resulting in plant loss. Mineral wool growth substrates are higher density. Foam blocks are often formaldehyde based foams and these tend to release formaldehyde which can result in plant loss. Foam does not retain water as well as other growth substrates such as mineral wool substrates. This is shown in U.S. Pat. No. 4,058,931 where the roots are guided by the bore through and out of the block into the nutrient fluid in the channel, rather than remaining in the block. The different properties of foam and mineral wool substrates mean that the two materials are not simply interchangeable.

According to a first aspect of the invention we provide a coherent growth substrate product formed of mineral wool, the product having two opposed top and bottom surfaces and a channel which is open at the bottom surface and extends from the bottom surface at least 50% of the height of the growth substrate product and wherein the volume of the growth substrate product is not more than 150 cm³.

We find that this product enables the grower to obtain, more easily than with prior art products, adequately high oxygen levels for the seed even when frequent watering is used, without water logging the growth substrate. We believe that this improved water-oxygen balance is associated with the presence of the channel in the product.

The product leads to numerous benefits, including an improved pattern of root growth and a compact root net. In particular, it leads to greater root weight, and a greater number of root branches, which leads to ultimately stronger plants at the end of the growing period. Use of the product of the first aspect of the invention leads to an increased rate of germination and improved plant uniformity.

According to a second aspect of the invention we provide a method of propagation of seeds comprising providing a product in accordance with the first aspect of the invention, positioning a seed at the top surface of the growth substrate product, irrigating the growth substrate product and allowing germination and growth of the seed to form a seedling.

In the preferred case where the growth substrate product has a channel which extends between the top and bottom surfaces and is open at both ends we also provide in a third aspect of the invention a method of positioning a seed in the growth substrate comprising providing the growth substrate product, positioning the seed at the top surface of the growth substrate, and applying vacuum at the bottom surface of the growth substrate product so as to draw the seed into the channel at the top surface of the growth substrate product. This optimises the contact of the seed with the surrounding growth substrate so as to obtain good positioning so as to achieve good water and oxygen contact with the seed. This achieves a good first stage of the propagation phase (bibition).

The growth substrate product of the first aspect of the invention can be made in various ways, including the process of the fourth aspect of the invention, which comprises providing a coherent mass of mineral wool having volume not more than 150 cm³ and opposed top and bottom surfaces and forming in the mass of mineral wool a channel extending from the bottom surface at least 50% of the height of the mass of mineral wool, wherein the channel is formed by punching.

An advantage of the process of the fourth aspect of the invention is that the punching step results in generation of a region of relatively high density around the channel. This has advantages in ensuring that there is concentration of water in the part of the growth substrate which is close to or in contact with the seed, which encourages improved rooting-in.

This can be achieved without excessively high water content in the remainder of the growth substrate product and hence without negative effects on the oxygen content of the growth substrate product.

In the preferred case where the growth substrate product has a channel which extends between the top and bottom surfaces and is open at both ends, the product can be made by the process of the fifth aspect of the invention. In this aspect we provide a process providing a mineral wool web, winding the mineral wool web on a mandrel and securing the wound web.

The growth substrate product of the invention is formed of mineral wool. The mineral wool can be of the conventional type used for formation of known mineral wool growth substrates. It can be glass wool or slag wool but is usually stone wool. Stone wool generally has a content of iron oxide at least 3% and content of alkaline earth metals (calcium oxide and magnesium oxide) from 10 to 40%, along with the other usual oxide constituents of mineral wool. These are silica; alumina; alkali metals (sodium oxide and potassium oxide) which are usually present in low amounts; and can also include titania and other minor oxides. In general it can be any of the types of man-made vitreous fibre which are conventionally known for production of growth substrates.

Fibre diameter is often in the range of 3 to 20 microns, in particular 5 to 10 microns, as conventional.

The growth substrate is in the form of a coherent mass. That is, the growth substrate is generally a coherent matrix of mineral wool fibres, which has been produced as such, but can also be formed by granulating a slab of mineral wool and consolidating the granulated material.

The mineral wool growth substrate usually comprises a binder, often an organic binder, which is generally heat-curable. The growth substrate is preferably a coherent matrix of mineral fibres connected by cured binder. The binder can be an organic hydrophobic binder, and in particular it can be a conventional heat-curable (thermosetting), hydrophobic binder of the type which has been used for many years in mineral wool growth substrates (and other mineral wool-based products). This has the advantage of convenience and economy. Thus, the binder is preferably a phenol formaldehyde resin or urea formaldehyde resin, in particular phenol urea formaldehyde (PUF) resin. The binder can be itself hydrophilic, for instance as described in EP1889859A. It can be a formaldehyde-free binder, such as in WO2008/028923 or EP1047645A, or phenol-free, as in WO2008/089849.

The binder is generally present in the mineral wool growth substrate in amounts of from 0.1 to 10% based on the substrate, usually 0.5 to 6%, most preferably 1.5 to 5%.

In the case where the binder itself is hydrophilic then wetting agent is not normally used, but in cases where the binder is not hydrophilic the mineral wool growth substrate preferably also comprises a wetting agent. This can be a conventional wetting agent such as a non-ionic surfactant. Alternatively it can be an ionic surfactant, preferably an anionic surfactant. For instance it can be any of the ionic surfactants described in our publication WO2008/009467.

The wetting agent is present in the growth substrate in amounts of preferably from 0.1 to 3% (by weight), based on growth substrate, more preferably 0.05 to 1%, in particular, 0.075 to 0.5%.

Preferably the amount (by weight) of wetting agent based on the weight of binder (dry matter) is in the range 0.01 to 5%, preferably 0.5 to 4%.

The mineral wool growth substrate may contain other types of conventional additives in addition to binder and wetting agents, for instance salts such as ammonium sulphate and adhesion promoters such as silanes.

Preferably the fibres are arranged predominantly in the vertical direction. This has the advantage of allowing better root growth than other orientations and enables the provision of a robust substrate which is useful during transplantation to the next stage.

The mineral wool growth substrate product may have dimensions conventional for the product type commonly known as a plug. Thus it may have height from 20 to 35 mm, often 25 to 28 mm, and length and width in the range 15 to 25 mm, often around 20 mm. In this case the substrate is often substantially cylindrical with the end surfaces of the cylinder forming the top and bottom surfaces of the growth substrate. Another embodiment has height from 30 to 50 mm, often around 40 mm and length and width in the range 20 to 40 mm, often around 30 mm. The growth substrate in this case is often of cuboid form. In this first case the volume of the growth substrate is often not more than 50 cm³, preferably not more than 40 cm³. Alternatively the growth substrate may be of the type described as the first coherent mineral wool growth substrate in our publication WO2010/003677. In this second case the volume of the growth substrate product is most preferably in the range to 10 to 40 cm³.

The height is the vertical height of the growth substrate when positioned as intended to be used and is thus the distance between the top surface and the bottom surface.

In general, the growth substrate may be of any appropriate shape including cylindrical, cuboidal and cubic.

In general the volume of the growth substrate product is in the range 5 to 150 cm³ and preferably not more than 100 cm³, more preferably not more than 80 cm³, in particular not more than 75 cm³, most preferably not more than 70 cm³.

The minimum distance between the top and bottom surfaces is preferably less than 50 mm, more preferably less than 40 mm and in particular less than 30 mm.

A single mineral wool growth substrate product will usually contain a single channel. Alternatively, a product may be provided which contains multiple channels, usually substantially identical in their form. A product of this sort may be used for propagation of multiple seeds. Alternatively, a product may be provided which is an array of connected mineral wool growth substrate products of the invention, connected for instance by grooves so that it is possible to break off one or more growth substrate products, each containing a single channel, either by hand or using some sort of blade or other suitable equipment.

In this case it is also possible for each growth substrate product to contain a seed hole or cut-out as discussed further below.

Another form of product is an array of mineral wool growth substrates according to the invention, connected by means of a film or sheet extending across and connected to the top surfaces of the growth substrate products. The film or sheet may be formed of any appropriate material, including polymeric materials such as biodegradable plastic, but paper is preferred. The covering sheet should be chosen so that it does not prevent the growth substrate product taking up water during initial wetting. It may be impermeable or may be porous, provided that the pores have diameter less than the width of the seed.

Usually the film or sheet is attached to the top surfaces of the growth substrate products using adhesive.

When required the covering sheet can be simply pulled away from the plugs. Paper as the covering sheet has an advantage that it disintegrates on wetting and so no step of active removal is required.

In a preferred embodiment of this array, the width of each channel at its narrowest point is less than or equal to (preferably less than) the width of a seed and each channel is provided with a seed. The covering film or sheet can protect and contain the seed within each growth substrate product.

One benefit of such an array is that it can be provided to a propagator in dry form but already filled with seeds so that the propagator does not have to undertake the time-consuming process of applying the seeds to the growth substrate products. The propagator needs only to undertake the wetting step to start the growth process. Furthermore, the covering sheet or film acts to connect the growth substrate products, allowing the propagator to dispense with a tray or other carrier. In some cases it can be preferred for the array to be provided with a second layer of the film or sheet (of the same type or a different type to that provided as the covering layer) along the bottom surfaces of the growth substrate products.

In such a case it is particularly advantageous for the growth substrates already to contain growth promoting chemicals such as hormones and/or pesticides and/or fertiliser and/or root stimulator. Alternatively or additionally, further growth promoting materials can be included together with the seed, for instance as a separate pellet placed under the covering sheet with the seed.

Such an array can be produced as follows:
1. Production of growth substrate material in coherent form.
2. Shaping of the growth substrate material into the form of the product having the required dimensions.
3. Forming a seed hole in the top surface.
4. Forming the channel, for instance by punching or drilling.
5. Positioning a seed in each seed hole.
6. If required, vermiculite can be positioned after positioning of the seed.
7. Positioning a covering sheet over the array and adhering it to the top surfaces of the growth substrates.

The direction of the channel is from the bottom to the top surface and is therefore substantially in the vertical direction when the product is in the as-used configuration.

The channel extends at least 50% of the distance between the top surface and the bottom surface and preferably at least 60%, in particular at least 70%. Preferably the channel extends from the bottom surface to the top surface and is open at both ends so that it is a through-going bore.

Generally the channel is positioned substantially centrally within the product. Its configuration is preferably such that the sides of the channel are essentially parallel and is generally cylindrical. Alternatively it may be conical, usually with the base of the cone being the opening point into the bottom surface.

The channel preferably has a volume in the range 0.5 to 15% of the total volume of the growth substrate product, in particular in the range 1 to 8% of the total volume.

When the channel is a through-going bore then it is important that its minimum width (i.e., the width at its narrowest point) is such as to prevent the seed from falling through the growth substrate and is not more than 5 mm, in particular not more than 4 mm. Generally it is at least 1 mm and preferably at least 2 mm, which allows a seed to be held in the top part of the channel at the top surface. Preferably the minimum width of the channel is around 3 mm.

The width of the channel at its top end can be greater than the width at its bottom end. This can provide flexibility to deal with variations in seed width.

Alternatively, the width of the channel at its bottom end can be greater than the width at its top end. When the channel is a through-going bore, this allows the channel to maximise oxygen supply to the seed.

Preferably the bottom surface of the growth substrate is substantially flat so that it can stand on a flat surface during the growing method.

The top surface, however, preferably has a cut-out (seed hole) into which the seed can be positioned and which preferably leads into the top opening of the channel in the case where it is a through-going bore. The cut-out may be substantially cylindrical but is preferably substantially conical or frusto-conical.

The positioning of the seed in the growth substrate, in use, is important. It is conventional in product types commonly known as plugs to include a seed hole in which the seed can be positioned. This seed hole may be a small cut-out in the centre of the top surface of the product. Alternatively, it may be a larger seed hole, formed as a cone that is cut out from most or all of the top surface of the product. It is also possible to combine these two options, by including a conical cut out in the top surface and, at the central point of the cone, a further smaller cut out into which the seed can be positioned.

Inclusion of a seed hole and, in use, correct positioning of the seed within the seed hole, is highly preferred so as to prevent seeds bouncing out from the surface of the product during positioning (which would of course lower the germination rate). It is also preferred that the seeds are positioned centrally on the top surface of the growth substrate product.

In the case where the channel is a through-going bore, then it may not be necessary to include a seed hole in the top surface, because the seed can be positioned within the top opening of the channel. Further, it may also be desirable, so as to ensure accurate positioning of the seed, to include either a cut-out which coincides with the exit of the channel from the top surface of the plug, or a conical cut-out of the top surface of the product, whereby the channel opens into the point of the cone in the top surface.

The average density of the product as a whole is in the range 60 to 100 kg/m³, preferably 70 to 85 kg/m³, preferably more than 55 kg/m³, preferably not more than 95 kg/m³, preferably not more than 90 kg/m³.

The average density of the product as a whole is preferably at least 55 kg/m³, preferably at least 60 kg/m³, preferably at least 70 kg/m³ to allow the product to be mechanically handled by the propagator with minimal loss for damaged products. The average density of the product as a whole is preferably less than 100 kg/m³, preferably less than 95 kg/m³, preferably less than 90 kg/m³, preferably less than 85 kg/m³, to allow plant roots to penetrate the product.

In preferred embodiments there is a region surrounding the channel which has higher density than the remainder of the growth substrate product. This region preferably extends at least 0.5 mm, preferably at least 1 mm, from the surface at the channel, but generally not more than 2 mm. The density of this densified region is preferably at least 5%, more preferably at least 10%, greater than the average density of the product as a whole. Most preferably it is in the range of 10 to 15% greater than the average density of the product as a whole.

This particular feature contributes to improvement of the water supply directly to the seed in the embodiments where the channel extends to the top surface. It is believed that this is because the seed is in contact with the region of higher density which can have higher water content than the remainder of the growth substrate without causing saturation of the remainder of the growth substrate.

The growth substrate product of the first aspect of the invention is for use in a method of propagation. This is as defined above in connection with the second aspect of the invention.

According to this method the growth substrate is preferably watered, by soaking or by the use of wetting lines, (or any other conventional wetting-up method), after which the seed is positioned in the growth substrate.

Positioning of the seed can be done in conventional manner and in the case where the channel is through-going bore extending from the bottom to the top surface it can be done by means of the method of the third aspect of the invention as described above.

In this method, a series of the products are positioned in an array, normally held in some sort of mould, which may for instance be made of stone wool. They may also be positioned in a tray. This arrangement can then be connected to a suction device which pulls air and the seeds into the top part of the through-going bore in each product.

After the seed has been positioned it can be covered with vermiculite, as conventional.

This embodiment is particularly useful where an array of growth substrate products is produced which are connected by means of a film or sheet. In such a case vermiculite is not needed and is preferably not used.

The seed is then allowed to root and grow in standard manner, normally for at least 2 days, often for at least 8 days and, depending upon the plant type, at least 10 days, and in some cases at least 14 or at least 16 days.

In the case of using the seedlings for grafting, the root stock is taken after up to 16 days and grafted. The grafted plant is then grown for a further 22 to 30 days to have a plant ready for the next growth stage.

The propagation method can be conventional or can be as described in our publication WO2010/003677.

After the propagation stage the seedling produced can be transferred, in the mineral wool growth substrate, to a further growth substrate to allow further growth to the final plant in conventional manner.

The plant can be any of the types conventionally grown from seed, including tomato, cucumber, sweet pepper and egg plant.

In the method of the second aspect of the invention, the mineral wool growth substrate product may have any of the preferred features discussed above in connection with the product of the first aspect of the invention.

A particular advantage of the propagation method of the invention is that it generates an improved root distribution in the eventual seedling. Accordingly, the invention also provides the use of a product of the first aspect of the invention in a method of propagation of at least 10 seeds to improve the root distribution, in particular to produce a more compact root net, especially in comparison with standard mineral wool growth substrates for propagation which do not have a channel.

A further advantage of the propagation method of the invention is that it generates improved root weight and an increased number of branched roots in seedlings. Accordingly, the invention also provides the use of a product of the first aspect of the invention in a method of propagation of at least 10 seeds to improve the root weight generated, especially in comparison with standard mineral wool growth substrate for propagation which do not have a channel.

The product of the first aspect of the invention can be made in any convenient manner. In general the product is generated using any of the known means for producing a growth substrate of the type used for propagation, to form a product without a channel. The channel can be generated by any suitable means, for instance by drilling or milling (or a combination of the two). However, we find that particularly desirable results are achieved when the channel is generated by punching, namely a method which does not result in removal of material from the product but instead displaces material resulting in increased density of the material surrounding the channel.

Thus, a preferred method of producing the product of the first aspect of the invention is by means of a method as defined in the fourth aspect of the invention.

According to this method a coherent mass of mineral wool is provided having appropriate characteristics for use as the growth substrate product and the required channel is generated in the coherent mass by punching. Forming the channel by punching (rather than some other means such as cutting or drilling which removes material from the coherent mass of mineral fibres) has the effect of compressing the mineral wool at the surface of the channel and increasing its density. We believe that this results in a structure which ensures that adequate water is always directed to the surface of the channel and hence close to the seed which is in contact with the surface of the channel at the top surface of the growth substrate product.

The punching equipment would normally have a pointed end, and could have different shapes, e.g. mandrel-like. The punching equipment could for instance have a width corresponding to the width of the desired channel. When making the channel in a growth substrate product, the punching equipment will be forced into the relevant surface of the growth substrate product and thereby displace the mineral wool outwardly. This way the displaced material will create a higher density in the growth substrate product surrounding the seed hole than for the rest of the growth substrate product.

In a fifth aspect of the invention the growth substrate product can be made by an alternative preferred method in which a mineral fibre web is produced and wound on an appropriately sized mandrel. After removal from the mandrel the product is generated having a through-going bore.

In this method preferably the mineral wool web contains binder in uncured form and the final product is cured, generally in an oven, after winding and removal from the mandrel.

The invention will now be illustrated with reference to the figures.

Following hereinafter are a number of drawings, with reference to which the mineral wool product and process of making the same according to the invention are further illustrated.

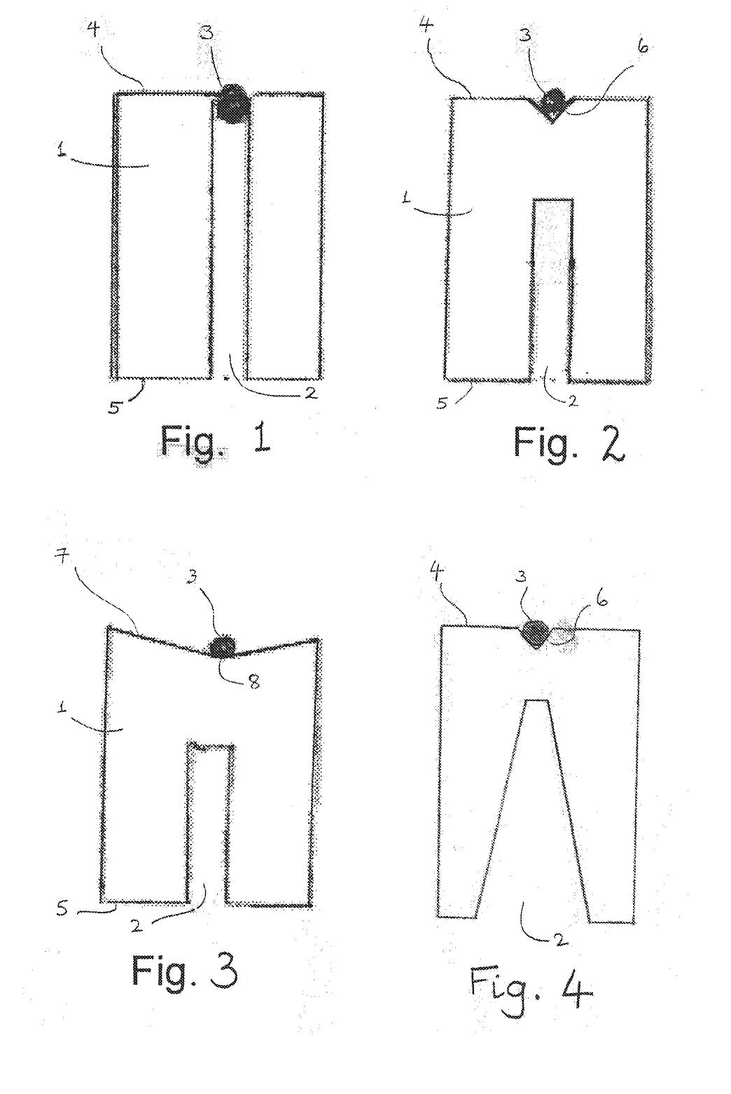

FIG. 1 is a schematic, cross sectional view of the mineral wool product provided with a through-going channel;

FIG. 2 is a schematic, cross sectional view of the mineral wool product with a channel and a seed hole on the top surface of the product;

FIG. 3 is a schematic, cross sectional view of an alternative embodiment of the mineral wool product with a channel and a seed hole in the top surface;

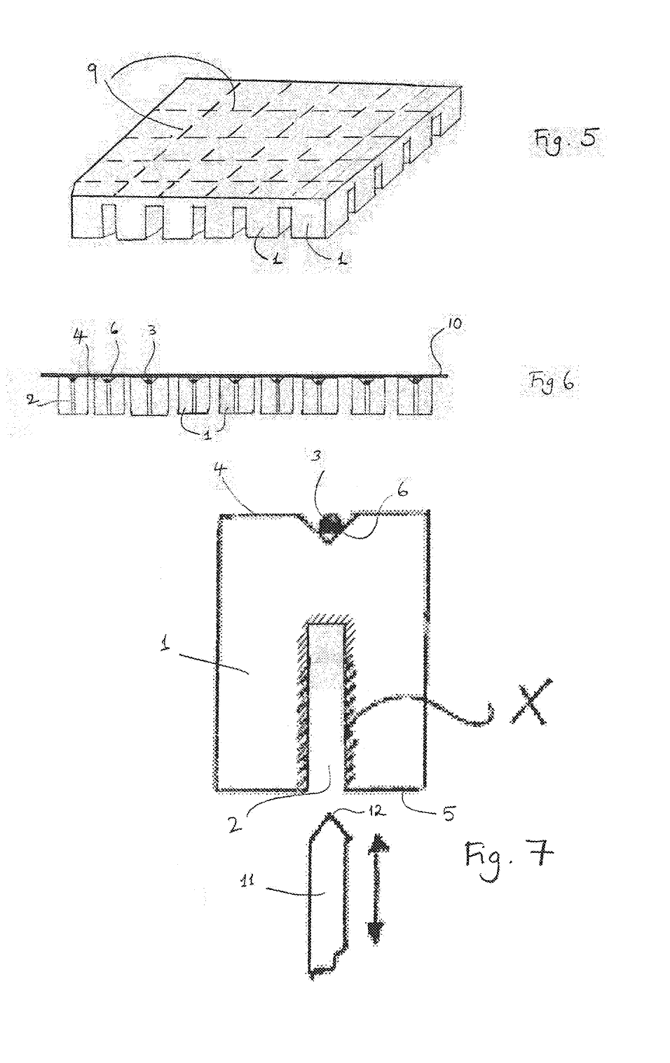

FIG. 4 is a schematic, cross sectional view of a second alternative embodiment of the mineral wool product with a channel and a seed hole in the top surface;

FIG. 5 is a schematic, perspective view of an array of growth substrate products;

FIG. 6 is a schematic, cross sectional view of an array of growth substrate products provided with seeds;

FIG. 7 is a schematic, cross sectional view of a growth substrate product and the means for making the hole and the compressed zone X;

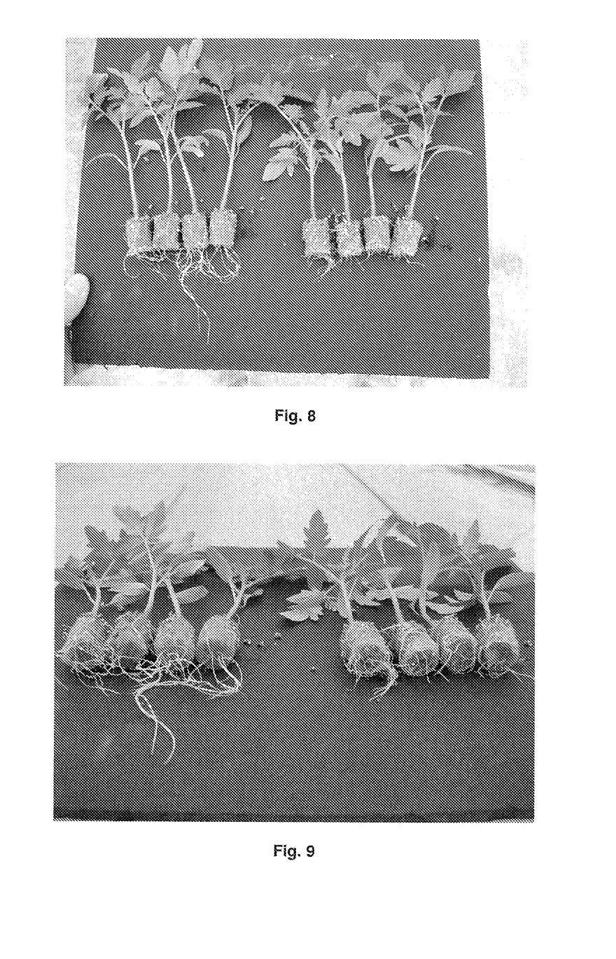

FIGS. 8 to 13 are photographs of the product illustrating the growth of the plant and the development of roots.

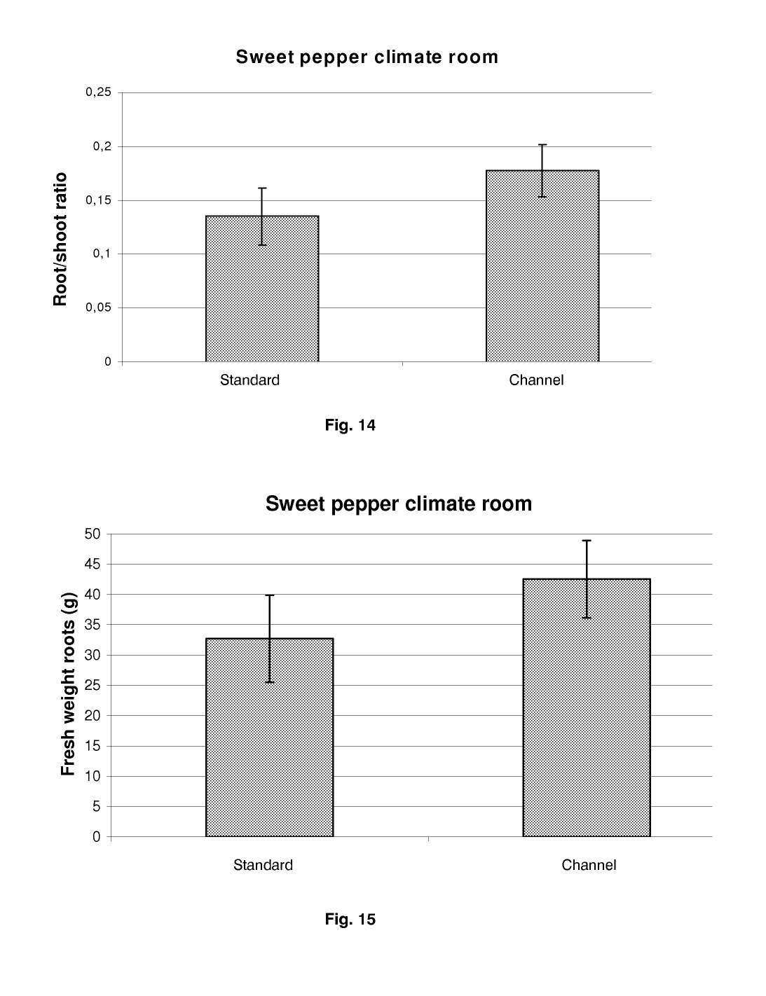

FIGS. 14 and 15 show the root/shoot ratio and the fresh weight of the roots of sweet pepper seedlings in comparative tests of standard products and products of the invention.

FIG. 1 shows a cross section of a growth substrate product 1 having a channel 2 which in this case is a through-going bore, a top surface 4 and a bottom surface 5. The channel is substantially centrally placed within the substantially cylindrical product. The seed 3 is positioned in the top opening of the through-going bore 2, which opens into the top surface into the product 1.

FIG. 2 shows another embodiment of the growth substrate 1, in which the channel 2 extends from the bottom surface 5 towards the top surface 4 but is not open at the top surface 4. In this case the top surface 4 has a small substantially conical cut-out 6 (a seed hole) in which a seed 3 is positioned.

In another embodiment, as shown in FIG. 3, the overall structure of the product 1 is essentially the same as in FIG. 2 except that the cut-out 7 is a large substantially conical cut-out having the central point of the cone substantially centrally positioned within the substantially cylindrical product. The seed 3 is positioned at the point 8 of the cone.

In a further embodiment, shown in FIG. 4, the top surface 4 is essentially as in FIG. 2, having a small conical cut-out 6 in which is positioned the seed 3. The channel 2 is differently formed and is frusto-conical.

It is of course possible to combine for instance the through-going bore form of channel shown in FIG. 1 with the small conical cut-out 6 shown in FIG. 2, in which case the channel 2 will open at the point of the cut-out 6. It is also possible to combine such a through-going bore channel 2 with the large form of cut-out 7, in which case the opening of the channel will be at the point 8 of the conical cut-out. Similarly, it is possible to combine the frusto-conical channel 2 shown in FIG. 4 with either of the forms of top surface shown in FIG. 3.

These embodiments illustrated in FIGS. 1 to 4 result in the growers obtaining adequately high oxygen levels for the seed even when frequent watering is used, without water logging the growth substrate. The improved water-oxygen balance is associated with the presence of the channel in the product.

FIG. 5 illustrates a product which is a joined array of growth substrate products 1. In this case they are formed as an integral array formed of mineral wool. In this Figure the channels are not illustrated. When it is required to use the products 1 then they can be broken from the array along the broken lines 9.

FIG. 6 shows a cross-sectional view of an array of separate growth substrate products 1, each having a through-going bore channel 2 which opens at the top surface 4 of the product into a small conical cut out 6 in which a seed 3 is positioned. The product 1 are not integrally formed but are joined by a sheet 10 which is attached to the top surfaces 4 of the product 1 using adhesive. Preferably the sheet is of paper.

Forming the product as an array has the benefit that it can be provided to a propagator in dry form but already filled with seeds so that the propagator does not have to undertake the time-consuming process of applying the seeds to the growth substrate products. The propagator needs only to undertake the wetting step to start the growth process. Furthermore, the covering sheet or film acts to connect the growth substrate products, allowing the propagator to dispense with a tray or other carrier.

FIG. 7 illustrates the means of producing the product of the invention by punching. In this case the channel 2 has been formed by means of a punching spine 11 having a pointed end 12 which is punched into the bottom surface 5 of the product to form the channel 2 as shown. Due to the fact that material is not being removed during this punching step but is only being outwardly displaced, a region of compressed mineral wool is generated at the surface of the channel. This is shown as shaded region X.

The benefit of this embodiment is that this results in a structure which ensures that adequate water is always directed to the surface of the channel and hence close to the seed which is in contact with the surface of the channel at the top surface of the growth substrate product.

FIGS. 8 to 15 illustrate the beneficial results of the invention. The products used are all mineral wool substrates with a phenol urea formaldehyde binder and a non-ionic surfactant as a wetting agent.

FIGS. 8 and 9 each show the contrast between the root systems generated for seedlings grown in products of the invention (on the right in the photographs) compared with standard products which do not have a channel. The products of the invention in this case are identical to the standard products but have a through-going bore as the channel. It can be seen that in the set of seedlings on the right the root systems are more compact.

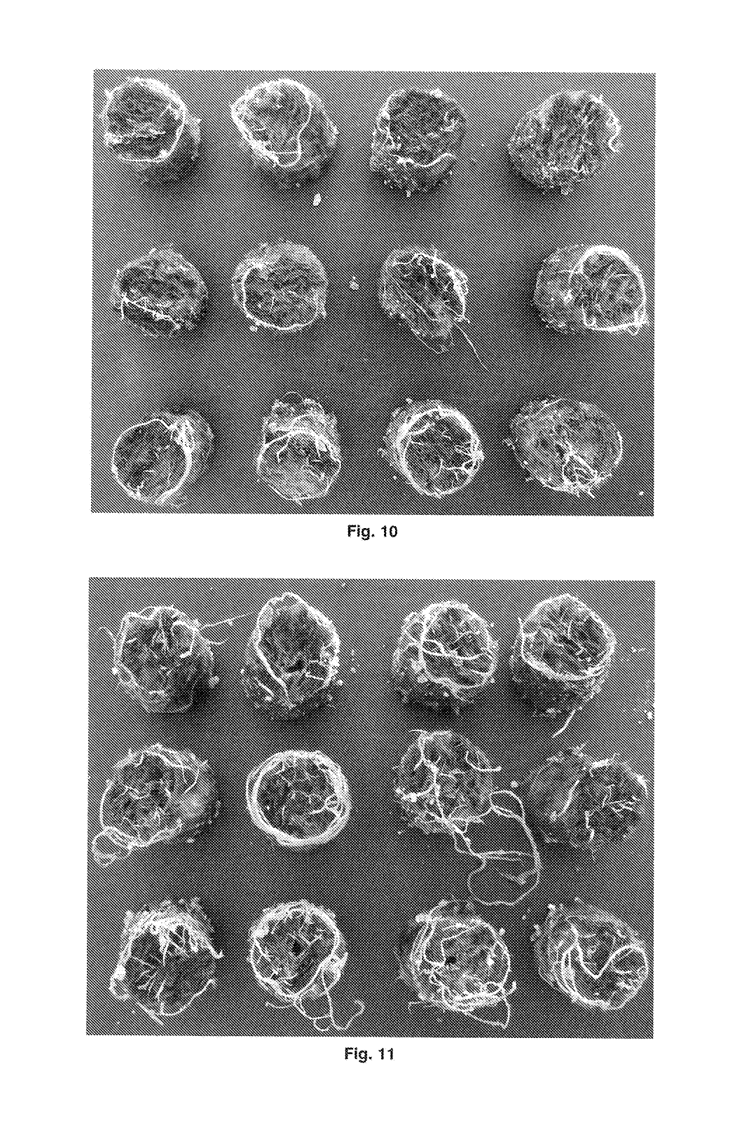

FIGS. 10 and 11 compare two sets of seedlings grown under the same conditions, in this case aiming for 50% water content in the growth substrate. FIG. 10 shows results in a product which does not have a channel. FIG. 11 shows the results for a product which is identical but has a through-going bore. It is clearly visible in FIG. 11 that the roots are thicker and the root mass is greater.

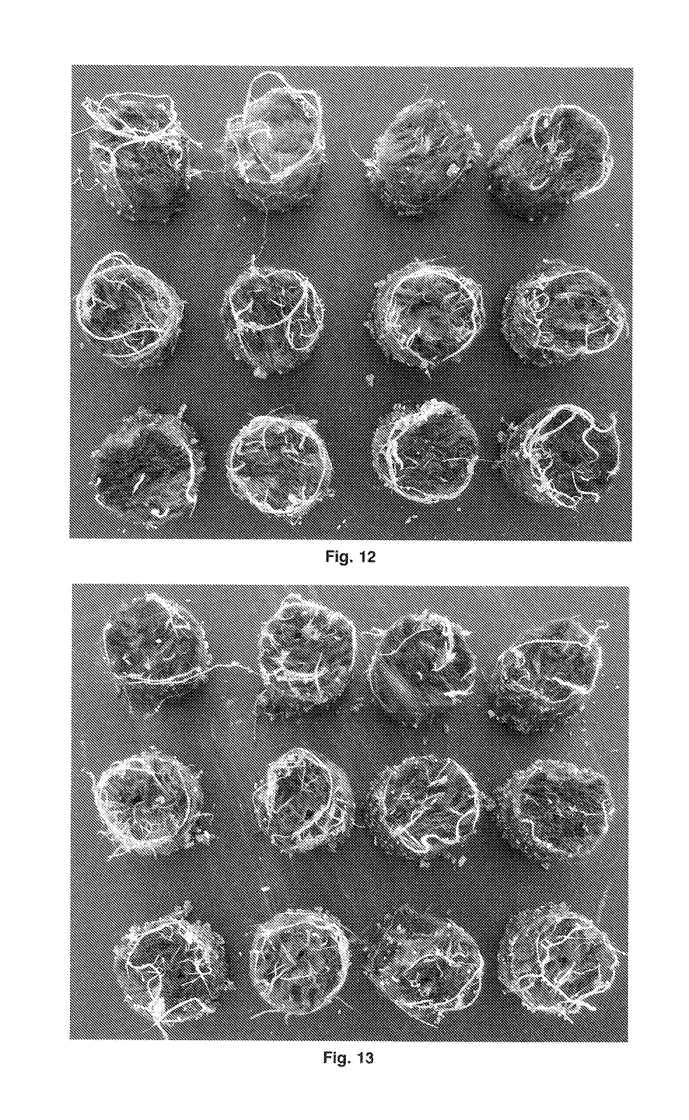

FIGS. 12 and 13 show a similar contrast, this time for conditions where the water content was set at around 70%. FIG. 12 shows the root systems in products which are of standard form and FIG. 13 shows results in products which are identical except that they have a through-going bore.

FIGS. 14 and 15 compare the root systems generated in sweet peppers in seedlings grown in products of the invention compared with standard products which are identical except that they do not have a channel. These seedlings were grown in winter period climate conditions with a standard irrigation strategy. The lighting was set at winter energy levels and a temperature of 20-22° C. FIG. 14 shows that the root/shoot ratio in the seedlings grown on the product of the invention is higher compared with standard products which do not have a channel. FIG. 15 shows that the fresh weight of the roots in the seedlings grown on the product of the invention is higher compared with standard products which do not have a channel. This shows that seedlings grown on products of the invention develop their rooting systems more than standard products which do not have a channel.

1. A coherent growth substrate product formed of mineral wool, the product having two opposed top and bottom surfaces and a channel which is open at the bottom surface and extends from the bottom surface at least 50% of the height of the growth substrate product and wherein the volume of the growth substrate product is not more than 150 cm³.

2. A growth substrate product according to claim 1 in which the channel extends continuously from the bottom to the top surface and is open at the top surface.

3. A growth substrate product according to claim 2 in which the channel has a width at its narrowest point of not more than 3 mm.

4. A growth substrate product according to claim 1 in which the density of the mineral wool immediately surrounding the channel is greater than the density of the remainder of the mineral wool forming the growth substrate product.

5. A growth substrate product according to claim 1 in which the mineral wool has an average overall density of from 60 to 100 kg/m³.

6. A growth substrate product according to claim 1 having at the top surface a substantially centrally positioned seed hole, wherein if the channel is open at the top surface, the seed hole coincides with the opening of the channel at the top surface.

7. A method of propagation of seeds comprising providing a product as defined in claim 1, positioning a seed at the top surface of the growth substrate product, irrigating the growth substrate product and allowing germination and growth of the seed to form a seedling.

8. A method according to claim 7 in which the growth substrate product is as defined in claim 2 and the seed is positioned within the channel at the top surface of the growth substrate product.

9. A method according to claim 8 in which the growth substrate product has the additional features defined in claim 2.

10. A method of positioning a seed for growth in a growth substrate, comprising providing a growth substrate product as defined in claim 2, positioning the seed at the top surface of the growth substrate, and applying vacuum at the bottom surface of the growth substrate product so as to draw the seed into the channel at the top surface of the growth substrate product.

11. A process of making a growth substrate product as defined in claim 1 comprising providing a coherent mass of mineral wool having volume not more than 150 cm³ and opposed top and bottom surfaces and forming in the mass of mineral wool a channel extending from the bottom surface at least 50% of the height of the mass of mineral wool, wherein the channel is formed by punching.

12. A process according to claim 11 in which the growth substrate product produced has the additional features defined in claim 2.

13. A process of producing a coherent growth substrate product according to claim 2 comprising providing a mineral wool web, winding the mineral wool web on a mandrel and securing the wound web.

14. A process according to claim 13 in which the mineral wool web contains uncured binder and the process additionally comprises curing the binder after winding is completed and the wound product has been removed from the mandrel.

15. A process according to claim 13 in which the growth substrate product has the additional features recited in claim 3.
